(19) United States
(12) Patent Application Publication
(10) Pub. No.: US 2014/0254821 A1
(43) Pub. Date: Sep. 11, 2014

(54) WHEEL COVER

(71) Applicant: Bernadette Boyce, Westfield, NJ (US)

(72) Inventor: Bernadette Boyce, Westfield, NJ (US)

(21) Appl. No.: 14/203,665

(22) Filed: Mar. 11, 2014

Related U.S. Application Data
(60) Provisional application No. 61/775,941, filed on Mar. 11, 2013.

(51) Int. Cl. B60Q 1/32; H04R 1/02; B60B 7/04

(52) U.S. Cl. CPC B60Q 1/326; B60B 7/04; H04R 1/028
USPC 381/86; 301/37.101; 301/37.109; 362/500

(57) ABSTRACT

The present disclosure describes and teaches a wheel cover that is used to cover the disc portion of a vehicle wheel. The wheel cover has at least an inner plate and an outer shield, both of which are attached to the wheel disc by screwing bolts and bolt heads, ensuring secure attachment of the wheel cover. The inner plate and the outer shield are preferred to have gaps and openings that are overlapping with the wheel spoke gaps. Preferably, the wheel cover also includes a set of audio speakers that are positioned between the inner plate and the outer shield, or beneath the inner plate. In either case, the audio speakers are disposed within the gaps and openings of the wheel cover, allowing more satisfying sound effects. The outer shield may have a decorative side that has patterns, logos, or pictures printed or engraved thereon.

### CLAIM OF PRIORITY

This application claims priority to U.S. Application Serial No. 61/775,941 entitled “Wheel Cover” which was filed on Mar. 11, 2013, the contents of which are herein incorporated by reference in its entirety.

### FIELD OF THE INVENTION

The invention relates to automobile accessories. In particular, the current invention relates to an ornamental and/or protective covering apparatus for automobile wheels.

### BACKGROUND OF THE INVENTION

Automobiles such as cars and trucks are an indispensible part of everyday life. In most cases, these automobiles use wheels that are mounted on a wheel hub connected to a brake disc. Aside from the tire, a wheel can be divided into a central disc portion and a peripheral rim portion. It is desirable that the center disc portion of the automobile wheels facing away from the automobile are covered for protective or ornamental purposes.

Nowadays, in general, the automobile manufacturers provide uniform wheel covers, center caps, and hubcaps. In most cases, these covering structures are added to improve aesthetic qualities of the wheels and the automobile as a whole. However, these factory-designed uniform wheel covers are not customarily made and may not fit the automobile owner's requirements or aesthetic preferences.

Another problem with the current uniform wheel covers is that the attachments are generally not secure enough. The disc portion of an automobile wheels generally does not include structures that can ensure a firm attachment. The common wheel covers and hubcaps used in current markets are “snapped” or “clipped” to a groove on the side of the wheel. Alternatively, some so-called “bolt-on” wheel covers and hubcaps are actually retained to the wheels by threaded fasteners engaging a receiving structure covering the bolt nuts on the wheels. These attachments, in general, are not very firm because the wheel covers and hubcaps are attached only to the outer surface of the wheels, not directly to the wheel hub to which the wheels themselves are attached.

Although the general concept of an automobile wheel cover is known in the art, the existing models suffer from shortcomings described above. On the other hand, the present invention addresses these issues with simple and elegant designs. Moreover, the current invention enhances the wheel cover function and aesthetic appeal by adding specific visual and audio elements.

### REVIEW OF THE RELATED TECHNOLOGY

U.S. Pat. No. 8,276,992 discloses a universal wheel cover assembly for covering a variety of different vehicle's wheels. The universal wheel cover assembly comprises: (a) a covering disc sized to cover the vehicle's wheel, (b) a universal bolt pattern plate, the universal bolt pattern plate including (i) a series of sections, each of the sections having a plurality of engagement members, wherein the sections are adapted for matching a pattern of threaded rods welded on the vehicle's axle hub used for attaching the vehicle's wheel, and (ii) a retaining system for connecting the universal bolt pattern plate to the covering disc, and (c) a spring biasing base comprising of a plurality of coil units, each coil unit for coupling one bolt in the pattern of bolts to the engagement members of the universal bolt pattern plate. The removable wheel cover assembly may be used in a variety of different vehicle tire rims and is aesthetically pleasing.

U.S. Pat. No. 7,471,966 discloses a selectively attachable wheel cover for a motor vehicle. The invention comprises a base member, a shaft member, and a display member. The base member is secured to the rim of a motor vehicle. The shaft member is connected to an outer portion of the base member, extending substantially transverse from the rim and substantially co-linearly with the longitudinal axis of the axle. The display member is connected to the shaft member such that it can rotate in relation to the base member and, thus, the rim. A portion of the display member is sufficiently weighted such that, when the rim rotates (when the vehicle is in motion) the display member remains substantially static.

Various implements are known in the art, but fail to address all the problems solved by the invention described herein. One embodiment of this invention is illustrated in the accompanying drawings and will be described in more detail herein below.

### SUMMARY OF THE INVENTION

The present invention discloses a wheel cover that may be used to cover the disc portion of a vehicle wheel. The wheel cover comprises: an inner plate having a wheel side, a shield side, and a plurality of inner plate through holes; and an outer shield having a shielding side, a decorative side, and a plurality of outer shield through holes, wherein the inner plate fittingly embraces the disc portion of the wheel, the wheel side of the inner plate faces the wheel, the outer shield covers the inner plate, the plate side of the outer shield facing the shield side of the inner plate, the inner plate through holes align with the outer shield through holes, capable of receiving bolts extending from a wheel hub and allowing bolt heads to affix both the outer shield and the inter plate to the wheel.

In the current invention, both the inner plate and the outer shield are affixed to the disc portion of the wheel with a bolt-bolt head combination. This design of the wheel cover ensures that it is fully secured to the wheel. Compared with the snap-on designs used by other wheel covers, which easily fall off, the design disclosed in the current invention effectively prevents theft and incidental loss and damages to the wheel covers.

The wheel cover as a whole provides ornamental and/or protective benefits to the wheel and the vehicle. The decorative side of the outer plate serves to improve the aesthetic appeal of the wheel cover. On the decorative side the outer plate, there may be images, logos, inscriptions, words, colors, and/or patterns, and any combinations thereof. These decorations may be printed or inscribed on the decorative side of the outer plate. In addition, there may be lights such as light-emitting diode (LED) attached to the decorative side, providing further ornamental effects, especially when the vehicle is moving and the wheels are rotating.

Preferably, the wheel cover further includes a set of speakers that serve as audio outlets for an external or on-vehicle audio player. The speakers may be mounted between the inner plate and the outer shield. Alternatively, the speakers may be positioned beneath the inner plate. For most wheel designs, there are wheel spokes on the disc portion radial-symmetrically distributed around a central axle and defining a series of wheel spoke gaps. Correspondingly, the inner plate and the outer shield have gaps that overlay wheel spoke gaps, wherein the speakers may be mounted. Such positioning allows the speakers to transmit and spread sound, providing more satisfying acoustic effects.

In another embodiment, instead of two layers, the wheel cover has only one layer, which may be considered a combination of the inner plate and the outer shield. The single-layered wheel cover may have a decorative side facing away from the wheel and a wheel side. Similar to the descriptions above: there are through holes on the wheel cover, allowing the fastening of the wheel cover to the wheel with bolt-bolt head combinations; the decorative side may bear various decorations to enhance aesthetic appeal; lights may be attached to the decorative side; and audio speakers may be attached to the gaps on the wheel cover, wherein the audio speakers may be positioned beneath the wheel cover.

Therefore, the present invention succeeds in conferring the following, and others not mentioned, desirable and useful benefits and objectives.

It is an object of the present invention to provide a wheel cover that is securely attached to the disc portion of a vehicle wheel.

It is another object of the present invention is to provide a wheel cover that is bolted, together with the wheel, to the wheel hub.

It is another object of the present invention is to provide a wheel cover that is either single-layered or double-layered.

Still another object of the present invention is to provide a wheel cover that is reasonably light and easy to handle.

It is another object of the present invention is to provide a wheel cover that is durable and strong, providing protection to the wheel.

It is another object of the present invention is to provide a wheel cover that is easy to manufacture.

Still another object of the present invention is to provide a wheel cover that has a decorative side.

Yet another object of the present invention is to provide a wheel cover having a decorative side with images, logos, inscriptions, words, colors, and/or patterns inscribed or printed thereon.

Still another object of the present invention is to provide a wheel cover that includes a set of audio speakers connected to an audio player.

Yet another object of the present invention is to provide a wheel cover having a decorative side with LED lights ornaments.

Still another object of the present invention is to provide a wheel cover that is capable of being firmly secured to the wheel.

### BRIEF DESCRIPTION OF THE DRAWINGS

FIG. 1 shows an exploded view of the preferred embodiment of the present invention, demonstrating the individual components.

FIG. 2 shows a perspective view of a car having a battery, which is connected to a set of audio speakers, as a part of the wheel cover.

FIG. 3 shows a front view of the preferred embodiment, demonstrating the decorative side of the outer shield and the speakers.

FIG. 4A shows a sectional view of the preferred embodiment at a wheel spoke location when the components are fully assembled.

FIG. 4B shows a sectional view of the preferred embodiment at a wheel spoke gap location when the components are fully assembled.

FIG. 5 is a front view of another embodiment of the present invention, demonstrating the decorative side of the outer shield and the ornamental disc.

### DESCRIPTION OF THE PREFERRED EMBODIMENTS

The preferred embodiments of the present invention will now be described with reference to the drawings. Identical elements in the various figures are identified with the same reference numerals. Such embodiments are provided by way of explanation of the present invention, which is not intended to be limited thereto. In fact, those of ordinary skill in the art may appreciate upon reading the present specification and viewing the present drawings that various modifications and variations can be made thereto.

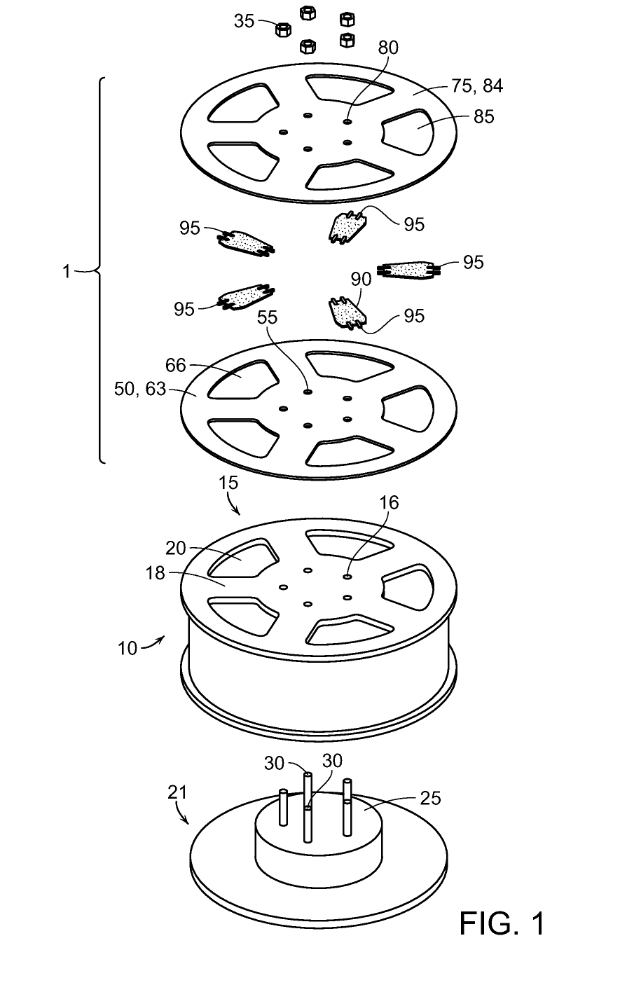

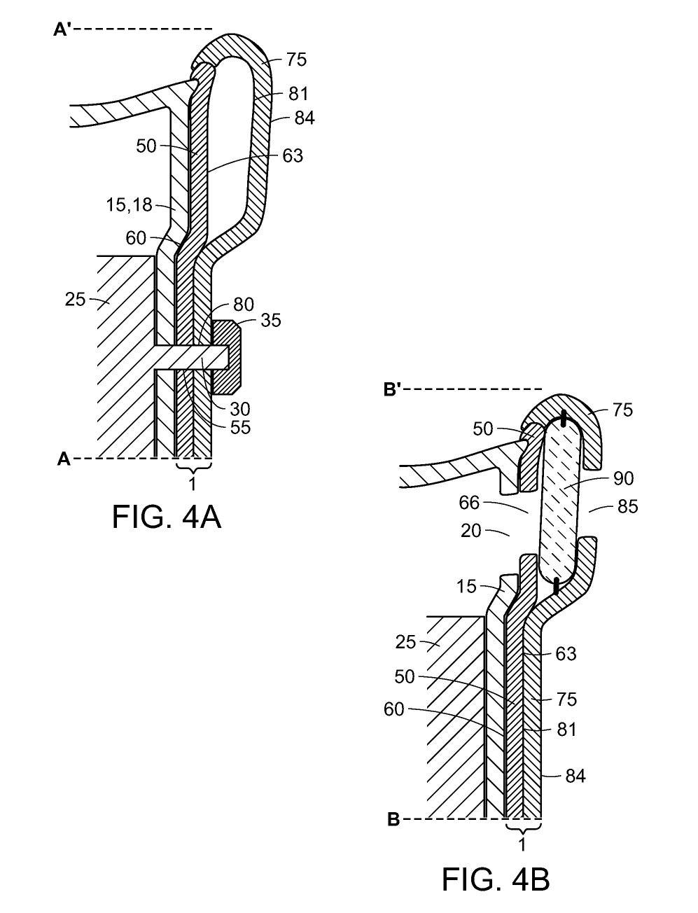

FIG. 1 shows an exploded view of the preferred embodiment of present invention, demonstrating the individual components in the relative positioning when they are assembled together. Shown in FIG. 1 are a wheel hub 25 attached to a brake disc 21, wheel bolts 30 extending from the wheel hub 25, a wheel body 10 that may be attached to the wheel hub 25, the wheel body 10 having a disc portion 15 with disc portion through holes 16, and a wheel cover 1 covering the disc portion 15 of the wheel body 10, the wheel cover 1 comprising an inner plate 50, the inner plate 50 having inner plate through holes 55, an inner plate wheel side 60 (shown in FIGS. 4A and 4B), and an inner plate shield side 63, and outer shield 75, the outer shield 75 having outer shield through holes 80, a shielding side 81 (shown in FIGS. 4A and 4B), and a decorative side 84. Also shown in FIG. 1 are a set of audio speakers 90 and speaker fasteners 95. The disc portion 15 of the wheel body has wheel spokes 18 radial-symmetrically distributed, defining wheel spoke gaps 20, partially exposing the structures inside the wheel. Similarly, while the inner plate 50 has inner plate gaps 66, the outer shield 75 has outer shield gaps 85, wherein the inner plate gaps 66 overlay with the outer shield gaps 85, as well as the wheel spoke gaps 20, if the wheel cover 1 is fully assembled. The speakers 90 are located between the inner plate 50 and the outer shield 75, behind the outer shield gaps 85, allowing efficient audio outlet. FIG. 1 also shows the bolt heads 35, which may be connected to the wheel bolts 30, securing the wheel body 10, the inner plate 50, and the outer shield 75 to the wheel hub 25. For clarity purposes, not all identical elements are fully marked.

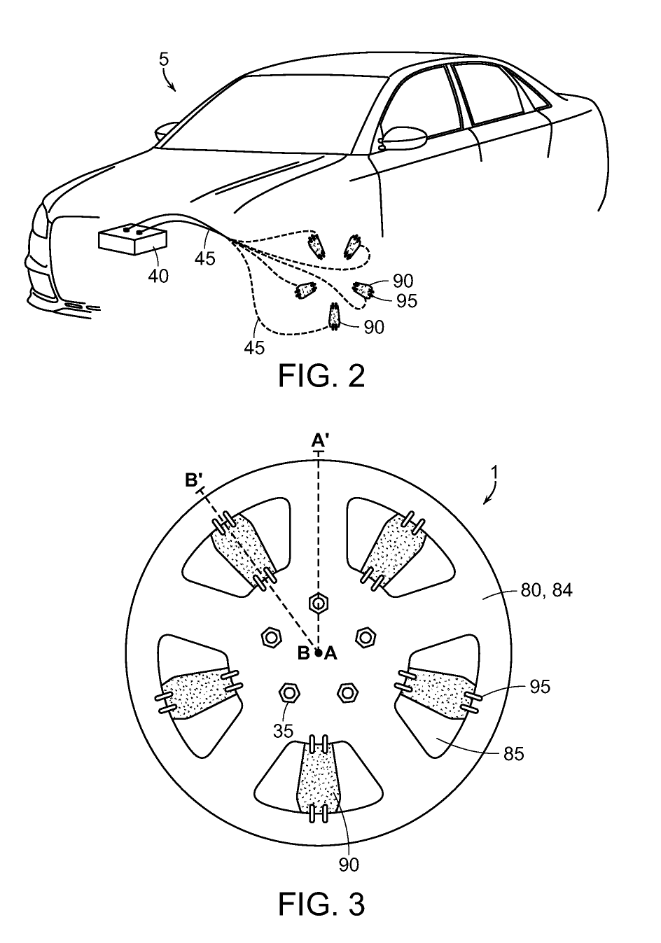

FIG. 2 shows a perspective view of a car 5 having a battery 40, which is connected to the speakers 90 through wires 45. Also shown in FIG. 2 are the speaker fasteners 95, affixing the speakers to the other parts of the wheel cover. For clarity purposes, not all identical elements are fully marked.

FIG. 3 shows a front view of the preferred embodiment when the components are fully assembled. Shown in FIG. 3 is the wheel cover 1 having an outer shield 80 with a decorative side 84 and outer shield gaps 85. Also shown in FIG. 3 are the bolt heads 35 and the speakers 90 positioned beneath the outer shield 80 and using the outer shield gaps 85 as sound outlets. For clarity purposes, not all identical elements are fully marked.

FIG. 4A shows a sectional view of the preferred embodiment when the components are fully assembled, at a wheel spoke location as indicated by A-A′ in FIG. 3. Shown in FIG. 4A are a wheel hub 25, wheel bolts 30 extending from the wheel hub 25, a disc portion 15 of a wheel body that is attached to the wheel hub 25, a wheel cover 1 covering the disc portion 15, the wheel cover 1 comprising an inner plate 50, the inner plate 50 having inner plate through holes 55, an inner plate wheel side 60, and an inner plate shield side 63, and an outer shield 75, the outer shield 75 having outer shield through holes 80, a shielding side 81, and a decorative side 84. The wheel bolts 30 extend through the holes on the disc portion 15, the inner plate through holes 55, and the outer shield through hole 80. The disc portion 15 of the wheel body has wheel spokes 18, which are embraced by the inner plate 50. Also shown in FIG. 4A are the bolt heads 35, which are connected to the wheel bolts 30, securing the wheel body 10, the inner plate 50, and the outer shield 75 to the wheel hub 25.

FIG. 4B shows a sectional view of the preferred embodiment when the components are fully assembled, at a wheel spoke gap location as indicated by B-B′ in FIG. 3. Shown in FIG. 4B are a wheel hub 25, a disc portion 15 of a wheel body that is attached to the wheel hub 25, a wheel cover 1 covering the disc portion 15, the wheel cover 1 comprising an inner plate 50, the inner plate 50 having an inner plate wheel side 60 and an inner plate shield side 63, and an outer shield 75, the outer shield 75 having a shielding side 81 and a decorative side 84. The disc portion 15 of the wheel body is embraced by the inner plate 50. Radial-symmetrically distributed wheel spokes define wheel spoke gaps 20, which overlap with inner plate gaps 66 and outer plate gaps 85. Also shown in FIG. 4B is the speaker 90 between the inner plate 50 and outer shield 75, the speaker 90 being positioned behind the outer shield gaps 85 and in front of inner plate gaps 66, allowing wires to go through and effective audio outlet. The speaker 90 is affixed to the outer shield 75 with speaker fasteners 95.

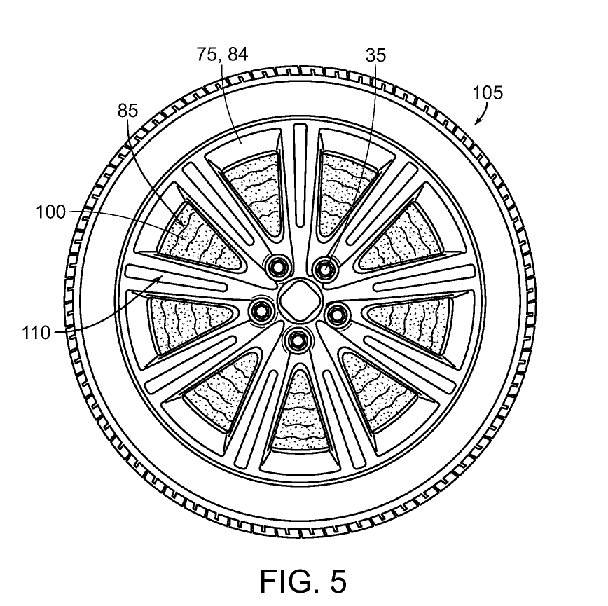

FIG. 5 shows another embodiment of the present invention. Here, a front view of a wheel employing the present invention is shown. The tire 105 surrounds the internal wheel structure. The outer shield 75 is plainly visible. The decorative side 84 may bear patterns, textures, logos, words, colors, and the like or some combination thereof. Further, the outer shield 75 has outer shield gaps 85. These gaps 85 allow the ornamental disc 100 to be visible to a passerby. The ornamental disc 100 may have various patterns, colors, textures, logos, engravings, words, images, and the like or any combination thereof. The ornamental disc 100 is preferably a plastic disc but may be composed of a number of suitable materials including metals, composites, resins, and the like or any combination thereof. There may be light emitting diodes 110 disposed along the outer shield 75 or the ornamental disc 100. The light emitting diodes 110 may flash in variable patterns and may flash in synchronization with music or other external stimuli. The configuration of the light emitting diodes 110 can vary and may be set in custom configurations depending on the desired preferences. The light emitting diodes may be integrated with the ornamental disc 100. The inner plate 50 (not shown), ornamental disc 100, and the outer shield 75 are held on the wheel hub 25 via wheel bolts 30 (not shown) and securing bolt heads 35. This embodiment is not limited to any particular design and may readily include components of other embodiments described herein and otherwise such as speakers.

The wheel cover 1 generally described by the figures has two essential components: the 1) inner plate 50 and the 2) outer shield 75. Both of these structures are fastened to the wheel body 1 with bolts 30 and bolt heads 35, ensuring a secure connection, preventing theft and incidental dislodging. As shown in FIGS. 1, 4A and 4B, the inner plate 50 is preferred to fittingly embrace the disc portion 15 of the wheel body 10, while the outer shield 75 may bend more away from the wheel to accommodate the speaker 90. As indicated above, in an alternative embodiment, the wheel cover 1 may include a single layer, combining the inner plate 50 and the outer shield 75. In that case, if the speakers 90 are also included, the single-layered wheel cover 1 may not fully embrace the disc portion 15 of the wheel, leaving space between the wheel cover 1 and the disc portion 15 for the installation of the speakers 90.

As shown in FIG. 3, the wheel cover 1, including the inner plate 50 and the outer shield 75, is preferred to have a round shape, ensuring full coverage of the disc portion 15. However, the wheel cover 1 may use different shapes. The sizes of the inner plate 50 and the outer shield 75—measured by the diameters of such components—may generally be close, wherein the outer shield 75 is the same or slightly bigger than the inner plate 50. However, in some special formats, the inner plate 50 may be larger than the outer shield 75. The sizes of the two structures may be adjusted to fit the varying sizes of the disc portion 15 of the wheel body. The diameters of the inner plate 50 and the outer shield 75 may range from 3 to 100 inches (7.62 cm to 2.54 m), with the preferred scope of 5 to 30 inches (12.7 cm to 76.2 cm). The average thickness of the inner plate 50 and the outer shield 75 may range from 0.1 to 200 mm.

The inner plate 50 and the outer shield 75 may be made from the same or different materials, which are preferred to be strong, durable, and moldable. For either the inner plate 50 or the outer shield 75, the structures can be uniform or uneven. The inner plate 50 and the outer shield 75 may be made from materials such as but not limited to: metals such as aluminum alloy, alloy, steel, and iron, plastics such as but not limited to polyvinyl chloride (PVC), polyvinylidene chloride (PVDC), polypropylene (PP), polystyrene (PS), high impact polystyrene (HIPS) and polycarbonate (PC), composite materials, glass or fiberglass, rubber, fabric, and/or any combinations thereof. Preferably, the materials making up the wheel cover 1 may be relatively light, allowing the wheel cover 1 to be portable, easy to install, and change.

The decorative side 84 of the outer shield 75 may bear images, logos, inscriptions, words, colors, and/or patterns, and any combinations thereof. These decorations may be printed, molded, or inscribed on the decorative side 75. The combinations and designs are almost limitless. Such additions may not only improve aesthetic appeal but also serve as promotional materials. In addition, there may be lights such as light-emitting diode (LED) attached to the decorative side 75, wherein the patterns and the LED light may change with factors such as but not limited to the speed of the vehicle, the ambient light, and/or the subjected to control of the user.

The speakers 90, as indicated in FIGS. 2 and 4A, may be positioned between the inner plate 50 and the outer shield 75. Alternatively, the speakers 90 may be disposed behind the inner plate 50—between the inner plate 50 and the disc portion 15 of the wheel. The speakers 90 may be any kind of electronic audio outlets and it may use any kind of power source. The speakers 90 may be connected to the car battery 40 using wires 45, as shown in FIG. 2. Nevertheless, the speakers 90 may be battery-powered so that no wires are needed, preventing complications in installation and accidental power loss.

The speaker 90 generally serve as audio outlets for an audio player, such as but not limited to the audio player or radio associated with the vehicle, or mp3, CD, or radio players off the vehicle. The wire 45, in addition to serving as power lines, may also carry audio signals to the speakers 90 from the audio player. Alternatively, wireless connection and transmission technology such as Bluetooth® may be used to transfer the signal from the audio player to the speaker 90, ensuring quality sound effects and avoid the complications associated with wire connections.

As shown in FIG. 4B, the speakers 90 are affixed the outer shield 75 using speaker fasteners 95. Alternatively, the speakers 90 may be attached to other parts of the wheel cover 1, such as the inner plate 50, or to the wheel body, such as the disc portion 15, or even to the wheel hub. The fasteners 95 may be any kind of connecting structure, such as but not limited to: a bolt on connection, a snap-on connection; a connecting strap, a magnetic attachment; a molded-on or welded-on connection, a hook and loop connection, or any combinations thereof.

The current invention discloses a wheel cover that provides a full range of functionalities, including improved protection and aesthetic appeals. In addition, the current invention develops an entertainment aspect for the automobile accessories. The inclusion of a set speakers allows the user to enjoy music and other audio programs when the vehicle is parked and the user is outside. Such a design is particularly useful for occasions such as social gathering and picnics.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A wheel cover covering a disc portion of a vehicle wheel, comprising:
an inner plate having a wheel side, a shield side, and a plurality of inner plate through holes; and
an outer shield having a shielding side, a decorative side, and a plurality of outer shield through holes, wherein
the inner plate fittingly embraces the disc portion of the wheel, the wheel side of the inner plate facing the wheel,
the outer shield covers the inner plate, the plate side of the outer shield facing the shield side of the inner plate,
the inner plate through holes align with the outer shield through holes, capable of receiving bolts extending from a wheel hub and allowing bolt heads to affix the outer shield to the inner plate and the inner plate to the wheel.

2. The wheel cover of claim 1, further comprising:
at least one speaker mounted between the inner plate and the disc portion.

3. The wheel cover of claim 1, further comprising:
at least one speaker mounted between the inner plate and the outer shield.

4. The wheel cover of claim 1, wherein
the inner plate has inner plate gaps that overlay wheel spoke gaps on the wheel body,
the outer shield has outer shield gaps that overlay inner plate gaps.

5. The wheel cover of claim 4, wherein
the inner plate gaps and the outer shield gaps are radial-symmetrical distributed around a central axle.

6. The wheel cover of claim 5, further comprising
at least one speaker mounted between the inner plate and outer shield, wherein the speaker is positioned underneath the outer shield and facing the outer shield gaps.

7. The wheel cover of claim 6, wherein
the speaker is connected to a vehicle battery with wires.

8. The wheel cover of claim 6, wherein
the speaker receives audio signals from an audio player.

9. The wheel cover of claim 1, wherein
there are images, logos, inscriptions, words, colors, and/or patterns, printed or inscribed on the decorative side of the outer shield.

10. A wheel cover covering a disc portion of a vehicle wheel, comprising:
an inner plate having a wheel side, a shield side, and a plurality of inner plate through holes;
an outer shield having a shielding side, a decorative side, and a plurality of outer shield through holes; and
a set of speakers mounted between the inner plate and the disc portion, wherein
the inner plate fittingly embraces the disc portion of the wheel, the wheel side of the inner plate facing the wheel,
the outer shield covers the inner plate, the plate side of the outer shield facing the shield side of the inner plate,
the inner plate has inner plate gaps that overlay wheel spoke gaps on the wheel body,
the outer shield has outer shield gaps that overlay the inner plate gaps,
the speakers are positioned underneath the outer shield and facing the outer shield gaps,
the inner plate through holes align with the outer shield through holes, capable of receiving bolts extending from a wheel hub and allowing bolt heads to affix the outer shield to the inner plate and the inter plate to the wheel, and
there are images, logos, inscriptions, words, colors, and/or patterns or any combination thereof printed or inscribed on the decorative side of the outer shield.

11. The wheel cover of claim 10, wherein
the speakers are connected to a vehicle battery with wires, and
the speakers receive audio signals from an audio player.

12. The wheel cover of claim 11, wherein the speakers receive audio signals wirelessly.

13. A wheel cover covering a disc portion of a vehicle wheel, comprising:
an inner plate having a wheel side, a shield side, and a plurality of inner plate through holes;
an outer shield having a shielding side, a decorative side, and a plurality of outer shield through holes, wherein
the inner plate fittingly embraces the disc portion of the wheel, the wheel side of the inner plate facing the wheel,
the outer shield covers the inner plate, the plate side of the outer shield facing the shield side of the inner plate,
the inner plate through holes align with the outer shield through holes, capable of receiving bolts extending from a wheel hub and allowing bolt heads to affix the outer shield to the inner plate and the inter plate to the wheel; and
an ornamental disc having a first side, a second side, and a plurality of ornamental disc through holes.

14. The wheel cover of claim 13 wherein the ornamental disc is positioned between the inner plate and the outer shield.

15. The wheel cover of claim 13 wherein the ornamental disc further comprises at least one light emitting diode.

16. The wheel cover of claim 13 wherein the wheel cover further comprises at least one light emitting diode.

17. The wheel cover of claim 13 further comprising at least one speaker wherein,
the at least one speaker is either wired or wireless.

18. The wheel cover of claim 13 wherein the ornamental disc has colors, designs, textures, words, patterns, images, engravings, or logos or any combination thereof disposed on at least one of the first and the second surface of the ornamental disc.

19. The wheel cover of claim 18 wherein the ornamental disc is visible through the outer shield gaps.

20. The wheel cover of claim 13 wherein the ornamental disc through holes align with the inner plate through holes and the outer shield through holes and wherein, the aligned through holes are capable of receiving bolts extending from a wheel hub and allowing bolt heads to affix the outer shield to the inner plate and the inner plate to the wheel with the ornamental disc positioned therebetween.
